(19) United States
(12) Patent Application Publication
(10) Pub. No.: US 2026/0241890 A1
(43) Pub. Date: Aug. 20, 2026

(54) Controlling a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/542,829

(22) Filed: Feb. 18, 2026

(30) Foreign Application Priority Data
Feb. 19, 2025 (JP) 10 2025 106 253.6

(51) Int. Cl. B60R 25/24

(52) U.S. Cl. CPC B60R 25/24; B60R 2325/103

(57) ABSTRACT

A method for controlling a motor vehicle includes steps of producing a wireless connection between the parked motor vehicle and a mobile device and providing vehicle data about the motor vehicle to the mobile device via the wireless connection. The vehicle data includes an identification of the motor vehicle, based on which a digital vehicle key for the motor vehicle can be produced.

### CROSS REFERENCE TO RELATED APPLICATION

This application claims priority under 35 U.S.C. §119 from German Patent Application No. 10 2025 106 253.6, filed February 19, 2025, the entire disclosure of which is herein expressly incorporated by reference.

### BACKGROUND AND SUMMARY

The present invention relates to the control of a motor vehicle. In particular the invention relates to the control of a motor vehicle which is secured by means of a digital vehicle key.

A motor vehicle is secured by means of a digital vehicle key. A predetermined security function of the motor vehicle, in particular unlocking a vehicle door or vehicle flap or starting a drive motor, is secured by means of the concept of a digital vehicle key. The published technical “Digital Car Key” specification from the Car Connectivity Consortium (CCC) is preferably followed.

In order to control the security function, a digital vehicle key can be stored on a mobile device as a cryptographic construct. This construct can be presented to the motor vehicle via a wireless interface, and the construct can be checked by the motor vehicle by means of a predetermined exchange process. If the check is successful, then the security function can be controlled.

The motor vehicle can be part of a vehicle fleet which comprises a large number of motor vehicles. A user of the mobile device can use a motor vehicle from the fleet by having a suitable digital vehicle key created by an external entity and delivered to the mobile device. For this purpose, the user can leaf through an online catalog of offered vehicles and determine a vehicle which corresponds to their expectations.

Vehicles from the vehicle fleet can be parked at a collection point. Should the user already be located directly by a motor vehicle which they would like to use, then finding the information which is required to create a digital vehicle key will be felt to be complicated. In addition, there is the danger of an erroneous allocation, so that under certain circumstances the user receives a vehicle key for a motor vehicle other than that intended.

An object on which the present invention is based consists in providing improved technology relating to the use of a motor vehicle secured by means of a digital vehicle key. The invention achieves this object by means of the subject matters of the independent claims. Sub-claims reproduce preferred embodiments.

According to a first aspect of the present invention, a method for controlling a motor vehicle comprises steps of producing a wireless connection between the parked motor vehicle and a mobile device; and providing vehicle data about the motor vehicle to the mobile device via the wireless connection; wherein the vehicle data comprises identification of the motor vehicle, on the basis of which a digital vehicle key for the motor vehicle can be produced. The technology described herein can be used in particular in combination with the proposals of the CCC relating to the Digital Car Key.

A user of the mobile device can better initiate a process of using a motor vehicle in the vicinity of which they are located. To this end, they can assess the real motor vehicle. Should the motor vehicle correspond to their expectations, then the user can determine the identification of the motor vehicle on site in the manner outlined. A diversion via a vehicle catalog or an interactive page of a management system can be dispensed with.

The identification of the motor vehicle can easily and securely be determined by the user by producing or permitting the wireless connection to their mobile device. The user obtains the identification of the motor vehicle at which they are located securely; an erroneous allocation can be avoided. The user can then request a digital vehicle key for the motor vehicle on the basis of the identification in order to use the motor vehicle.

In one embodiment, the vehicle data additionally comprises an indication of a feature or a capability of the motor vehicle. On the basis of the indication, the user can better decide whether they wish to use the motor vehicle. Such a feature can comprise, for example, a drive power, an available special accessory or equipment. Further possible information comprises, for example, a mileage reading, a maximum loading or conditions under which the motor vehicle can be used. The conditions can in particular indicate a group of persons who can use the motor vehicle or a fee which is demanded for the use of the motor vehicle. The indication can additionally comprise information with which it is possible to check whether the identification also relates to the intended motor vehicle. Such information can comprise easily comprehensible and/or unique features, for example a vehicle type, a vehicle color, and/or a license plate.

The identification can further comprise an indication of an external entity which is set up to create a digital vehicle key for the motor vehicle. The entity is preferably external both to the motor vehicle and to the mobile device. More preferably, the external entity is set up to manage vehicles of a predetermined vehicle fleet, wherein the present motor vehicle belongs to the vehicle fleet. The indication of the external entity can be used immediately in order to contact the external entity from the mobile device and, for example, consist in the form of a URL or a similar machine-evaluable address. It is possible to dispense with cumbersome entry of the address of the external entity. Here, too, an erroneous allocation can be avoided so that the correct external entity can always be contacted.

In a further embodiment, an indication of a feature or a capability of the motor vehicle is transmitted to the mobile device by the external entity. The indication can in particular comprise information which is described above with respect to the indication provided directly by the motor vehicle but also other or additional information. Indications of a feature or a capability of the motor vehicle can be provided both by the motor vehicle and by the external entity, wherein the provided information may overlap or be disjoint.

On the basis of the collected information, a vehicle key for controlling the motor vehicle can now be created and stored on the mobile device. The generation operation is preferably carried out as is described in more detail in the specification of the digital key of the CCC. In a preferred embodiment, the vehicle key is created by the mobile device and then signed by the external entity. To this end, the unsigned vehicle key can be transmitted from the mobile device to the external entity and the signed vehicle key or only its signature can be transmitted back to the mobile device.

In a further embodiment, the vehicle key is created by the external entity. To this end, the identification can be transmitted from the mobile device to the external entity; and the vehicle key created can be transmitted from the external entity to the mobile device.

Communication between the mobile device and the external entity is usually carried out by means of a radio technique other than that which is used for the communication between the mobile device and the motor vehicle. In particular, mobile radio can be used to communicate between the mobile device and the external entity.

The digital vehicle key is preferably created by the external entity on the basis of the identification of the motor vehicle. Still further information may be required for the generation, in particular an identification of the mobile device or its user. Under certain circumstances, still further information is required which is technically not bound up with the generation of the vehicle key but is used as a precondition for the generation method. Such information can in particular comprise account or billing information relating to the use of the motor vehicle.

The external entity can additionally transmit to the motor vehicle information which is required for the use of the digital vehicle key of the mobile device. Within the context of the Digital Car Key, this information is known as an attestation package. The attestation package can be transmitted to the motor vehicle from the external entity by means of still further radio technology, usually by means of mobile radio. Should the direct transmission of the attestation package not be possible, for example because a wireless connection cannot be produced, then the attestation package can also be transmitted to the mobile device, so that the latter can transmit the attestation package to the motor vehicle before the digital vehicle key is presented to the motor vehicle.

In a further preferred embodiment, the wireless connection by which the vehicle data about the motor vehicle is transmitted to the mobile device is produced by means of a connection technology via which a digital vehicle key can be presented to the motor vehicle. The presentation may comprise the completion of a predetermined process in order to carry out mutual authentication of the motor vehicle and of the mobile device on the basis of the respective cryptographic constructs. Information flows which are necessary to permit the user of the mobile device to use the motor vehicle can thus be completed without any media disruption between the mobile device and the motor vehicle. However, it is also possible to use different communication techniques for the vehicle data and the presentation of the digital vehicle key.

In a particularly preferred embodiment, the wireless connection for transmitting the vehicle data is produced by means of short-range radio. The short-range radio is used as a point-to-point connection between the mobile device and the motor vehicle. A range of the short-range radio is limited, usually to a distance of a few centimeters up to a few meters.

In a particularly preferred embodiment, the wireless connection is produced by means of near-field communication (also NFC). A range of NFC is usually only a few centimeters. A transceiver on the motor vehicle can be attached, for example, in the vicinity of a door handle. The user can easily find this entity and bring their mobile device into this region. As a result of the low range of the radio technology used, disruption of the data traffic or an erroneous allocation of the motor vehicle can be avoided. In a further embodiment, the wireless connection can also be produced by means of another wireless technology, in particular by means of Bluetooth (BT) or Bluetooth low energy (BLE).

The external entity is preferably set up to manage digital vehicle keys for a predetermined fleet of vehicles, wherein the fleet comprises the motor vehicle. In one embodiment, the external entity is a server based owner device (SBOD). In another embodiment, the external entity is a server based friend device (SBFD). Usually, a larger fleet, which can comprise a few tens to several thousand vehicles, is managed by means of an SBOD. Such large fleets are formed, for example, by company or rental vehicles. A smaller fleet which, for example, can comprise only two to a few tens of vehicles, is frequently managed by means of an SBFD.

The external entity can be set up to manage a fleet of rental vehicles which can be made accessible to an open or closed group of users. The external entity can also, for example, manage an operational fleet of a predetermined organization or of an enterprise. In this case, a closed user group is provided, which can comprise employees of the organization or of the enterprise.

In both cases, specific motor vehicles may be accessible only to specific users. Thus, for example, a particularly complicated or powerful motor vehicle can be made accessible only to a user who has an appropriate status in the organization or sufficient driver experience.

According to a further aspect of the present invention, a control device for a motor vehicle comprises an interface for producing a wireless connection to a mobile device; and a processing device. The processing device is configured to provide vehicle data about the motor vehicle to the mobile device via the wireless connection. The vehicle data comprises an identification of the motor vehicle, on the basis of which a digital vehicle key for the motor vehicle can be created.

The processing device is preferably configured to partly or completely carry out a method described herein. To this end, the processing device can be designed to be electronic and, for example, comprise an integrated circuit, a programmable logic module or a programmable microcomputer. The method can be implemented in the form of a configuration or as a computer program product having program code means for the processing device. The configuration or the computer program product can be stored on a computer-readable data carrier. Features or advantages of the method can be transferred to the device or vice versa.

The control device can be installed on board a motor vehicle described herein. Communication flows or processing steps which are described in simplified form herein with respect to the motor vehicle can be implemented physically by the control device.

The control device is preferably additionally configured to use the wireless connection to verify a digital vehicle key for the motor vehicle that is stored on the mobile device; and to release a security function of the motor vehicle.

The verification of the digital vehicle key can be carried out via the same wireless connection via which vehicle data about the motor vehicle has also been transmitted to the mobile device, or via another connection. In one embodiment, the vehicle data is transmitted via an NFC connection, while the vehicle key is validated with respect to the motor vehicle by BLE.

According to a still further aspect of the present invention, a motor vehicle comprises a control device described herein. The motor vehicle can in particular comprise a passenger car. However, according to a further aspect of the present invention, a mobile device comprises an interface for producing a wireless connection to a motor vehicle; and a processing device, which is configured to receive vehicle data about the motor vehicle via the wireless interface. The vehicle data comprises an identification of the motor vehicle, on the basis of which a digital vehicle key for the motor vehicle can be created.

The control device further preferably comprises a processing device, which can likewise be configured to at least partly carry out a method described herein. Advantages or features of the method can be transferred to the control device and vice versa.

The mobile device can be assigned to a predetermined user and in particular a smart phone, a smartwatch, a tablet computer, a laptop computer or a portable computer (wearable computer). The mobile device can comprise a secure memory, in which the digital vehicle key for the motor vehicle can be stored. In order to make access to the secured memory, it may be necessary that the user authenticates themself with respect to the mobile device. This can in particular be carried out by presenting a biometric feature or by entering a predetermined secret.

The mobile device can have a further interface for producing a wireless connection to an external entity which is set up to create a digital vehicle key for the motor vehicle. The further interface is preferably configured for long-range transmission and can in particular support mobile radio or WLAN.

In addition, a third wireless interface can be provided on the mobile device, via which the digital vehicle key can be presented to the motor vehicle or a process for the verification of the motor vehicle key by the motor vehicle can be completed. For this purpose, however, the wireless connection by which the vehicle data about the motor vehicle has been received can also be used.

Further preferably, the mobile device comprises a user interface to provide an indication to a user, determined on the basis of vehicle data, of a feature or a capability of the motor vehicle. The user interface can in particular comprise an optical output device. The user interface can also comprise an input device, with which the user can make an input on the mobile device. The processing device of the mobile device is preferably configured to detect a confirmation of the user in response to a provided indication of a feature or a capability of the motor vehicle; and to send a request to create a digital vehicle key to the external entity.

In a practical embodiment, the indication can, for example, comprise a graphic or symbolic representation of the motor vehicle and an example of a textual representation of a feature or a capability of the motor vehicle. The user can confirm the indication and therefore initiate the process of generating a digital vehicle key.

The invention will now be described in more detail with reference to the appended drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system;

FIG. 2 illustrates a flowchart of a method; and

FIG. 3 illustrates details of the method from FIG. 2.

### DETAILED DESCRIPTION OF THE DRAWINGS

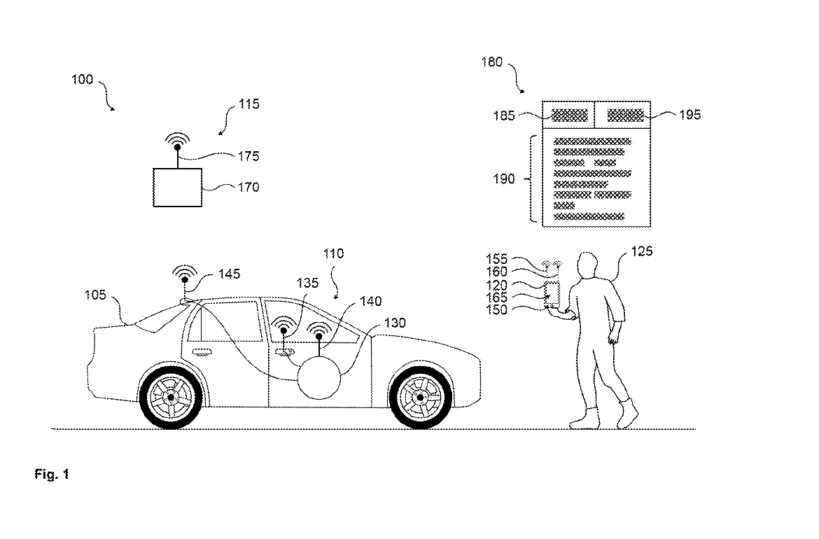

FIG. 1 shows a schematic illustration of a system 100. The system 100 comprises a motor vehicle 105 having a control device 110 and an entity 115 external to the motor vehicle 105. In addition, a mobile device 120 can be provided, which is preferably assigned to a predetermined user 125.

The control device 110 comprises a processing device 130 which, in the present illustration, is connected to a plurality of wireless interfaces. It should be noted that in other embodiments it is also possible to use fewer or other than the illustrated interfaces, wherein different functions can possibly be controlled via an interface. A first wireless interface 135 is preferably configured for near-field communication and can in particular be implemented by means of NFC. A transmitting/receiving device (transceiver) can be arranged, for example, in the region of a door handle of the motor vehicle 105. The first wireless interface 135 is preferably configured for point-to-point communication in particular with the mobile device 120.

A second wireless interface 140 is preferably likewise configured for point-to-point communication, in particular with the mobile device 120, and can, for example, operate on the basis of Bluetooth or Bluetooth low energy. Both the first wireless interface 135 and the second wireless interface 140 can be used to validate a digital vehicle key, which is stored on the mobile device 120, by means of a predetermined process. A range of the second wireless interface 140 is usually greater than a range of the first wireless interface 135.

Furthermore, a third wireless interface 145 can be provided, via which long-range communication is also made possible, in particular with the external entity 115. The third wireless interface 145 can, for example, operate on the basis of WLAN or mobile radio.

The control device 110 is preferably configured to control a security function of the motor vehicle 105. The security function can in particular relate to unlocking a vehicle door or starting a drive motor. The security function can be requested by means of the mobile device 120 via one of the interfaces 135, 140 and is carried out only when a digital vehicle key stored on the mobile device 120 can be successfully validated.

The mobile device 120 comprises a processing device 150, a first wireless interface 155 for communication with the control device 110 of the motor vehicle 105 and also a second wireless interface 160 for communication with the external entity 115. The first wireless interface 155 is preferably configured for communication by means of NFC or BT/BLE. Optionally, separate first wireless interfaces 155 can also be provided for this purpose. The second wireless interface 160 preferably operates by means of mobile radio/WLAN; here, too, different second wireless interfaces can be provided for the different technologies.

In addition, a user interface 165 is preferably provided, which is configured to provide information to the user 125 and/or to acquire an input from the user 125. In an exemplary embodiment of the invention, the user interface 165 comprises a touch-sensitive screen (touchscreen).

The external entity 115 comprises a processing device 170 and a wireless interface 175. The wireless interface 175 is configured to communicate with the mobile device 120 and/or the motor vehicle 105. To this end, for example, mobile radio or WLAN can be used; other technologies are likewise possible.

It is assumed that the user 125 is located by the motor vehicle 105 and wishes to gain access to the motor vehicle 105. For this purpose, they can couple their mobile device 120 to the control device 110 of the motor vehicle 105 in a wireless manner in order to receive vehicle data 180 about the motor vehicle 105, which comprises identification 185 about the motor vehicle 105 and the control device 110. In addition, the vehicle data 180 can comprise features and/or capabilities 190 of the motor vehicle 105. Furthermore, an address 195 of the external entity 115 can be specified in the information.

At least some of the information 190 can be output to the user 125 by means of the user interface 165. Optionally, the external entity 115 can be contacted and, on the basis of the identification, further features or capabilities 190 of the motor vehicle 105 with respect to the identification 185 can be downloaded. Such information 190 can also be provided to the user 125 via the user interface 165.

Preferably following the input of a confirmation by the user 125, a request to create a digital vehicle key for the motor vehicle 105 can be transmitted to the external entity 115 by the mobile device 120. The external entity 115 can check whether the request is to be carried out and, if successful, create a digital vehicle key for the mobile device 120 and the user 125 and transmit it to the mobile device 120 in a wireless manner. In another embodiment, the digital vehicle key is created directly on the mobile device 120 and then signed cryptographically by an entity which is authorized to create vehicle keys for the motor vehicle 105. In one embodiment, this can comprise the external entity 115. This procedure is described with respect to the digital key of the CCC under the designation Cross Platform Sharing.

In addition, a created vehicle key can be tracked by a further entity, which can be called the Key Tracking Service (KTS). The further entity can be configured to track every vehicle key for the motor vehicle 105, so that, in respect of an arbitrary point in time, it is possible to determine which vehicle keys were active for the motor vehicle 105. In one embodiment, the external entity 115 performs the tracking of the vehicle key.

In addition, an attestation package with respect to the created vehicle key can be created and transmitted to the motor vehicle 105 or to the control device 110. The attestation package can be produced by that entity which validates and signs the vehicle key.

The user 125 can present the obtained digital vehicle key to the motor vehicle 105 by means of the mobile device 120 and have it validated. If the vehicle key has been accepted, then the user 125 can use the motor vehicle 105.

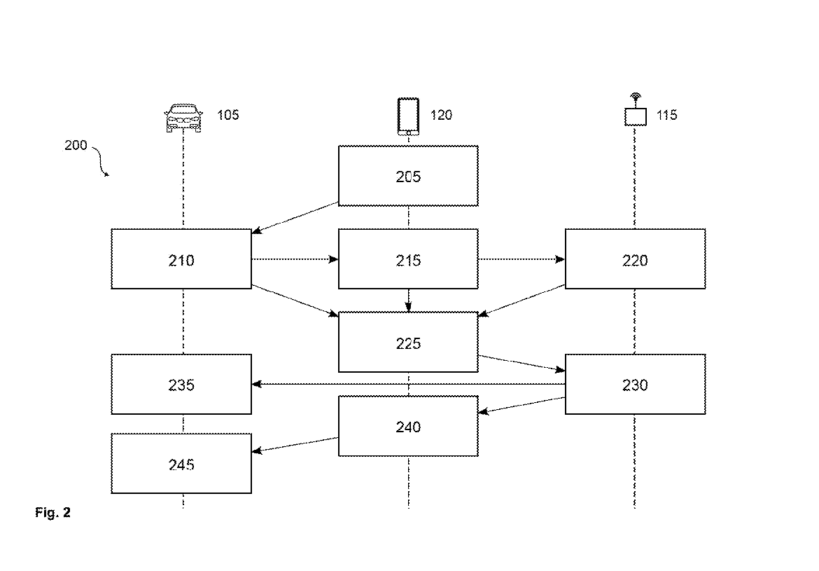

Such a procedure will now be described in more detail with reference to FIG. 2. FIG. 2 shows a flowchart of an example of a method 200 for controlling the motor vehicle 105. Method steps which are associated with the motor vehicle 105 and the control device 110 are illustrated in a left-hand region. Method steps which are associated with the mobile device 120 will be found in a central region. Method steps which are associated with the external entity 115 are illustrated in a right-hand region. It should be noted that, in other embodiments, still further entities, not illustrated here, may be involved, for example a relay server. Details in this regard will be found in the mentioned technical specification of the Digital Car Key from the CCC.

In a step 205, a wireless connection is produced between the mobile device 120 and the motor vehicle 105. This connection preferably comprises near-field communication, in particular by means of NFC. Optionally, authentication can be carried out between the mobile device 120 and the control device 110.

In a step 210, vehicle data 180 can be provided to the mobile device 120 by the motor vehicle 105. The vehicle data 180 can in particular comprise an identification 185 of the motor vehicle 105 or its manufacturer, an identification or address 195 of an associated external entity 115 or an organization operating the entity 115, and/or an identification of a fleet of vehicles to which the motor vehicle 105 belongs. According to the CCC proposals, the identification of the external entity 115 or its operator and the fleet to which the motor vehicle 105 belongs is not yet specified. In one embodiment, this information is formatted in a way analogous to existing information. An identification or address 195 of the external entity 115 or its operator can be formatted in a way analogous to the service provider ID. The identification of the fleet can be formatted in a way analogous to the service ID.

In a step 215, the mobile device 120 can request further information with respect to the motor vehicle 105 from the external entity 115. For this purpose, the vehicle data 180 provided by the vehicle 105 can be used as a reference. The external entity 115 can provide the further information in a step 220. The information can in particular relate to a feature or a capability 190 of the vehicle 105, for example a vehicle model, an age, a mileage reading, a range, a type of drive or other, in particular technical, parameters. It is also possible to append information which specifies conditions under which the user 125 can use the motor vehicle 105. The conditions can in particular comprise a fee or a request for a status, a rank or a capability of the user 125. Should the information 190 not be installed in the external entity 115, then it can be appropriately created or requested.

In a step 225, received information 190 regarding the motor vehicle 105 can be provided to the user 125 by the mobile device 120 The information can be provided to the mobile device 120 by the external entity 115 in step 220 and/or by the motor vehicle 105 in step 210. It is also possible for information to be received from the two sources 105, 115 and combined or compared with each other before it is provided to the user 125 on the mobile device 120.

Likewise in step 225, an input from the user 125 can be acquired, which can be given as a response to the provided information. The input can relate to an agreement of the user 125 to use the motor vehicle 105. If the motor vehicle 105 is a rental vehicle, the user 125 can conclude a rental contract as a result. A request to produce a vehicle key can then be transmitted from the mobile device 120 to the external entity 115.

The external entity 115 can share the requested vehicle key in a step 230. For this purpose, information which has been provided by the motor vehicle 105 in step 210 can be used, in particular an identification 185 of the motor vehicle 105. Further information can relate to the mobile device 120 or the user 125 and have been collected in step 225. Details relating to the creation of a digital vehicle key by the external entity 115, in particular if it is implemented as SBOD or SBFD, can be taken from the current technical specification of the Digital Car Key of the CCC.

The vehicle key produced is then transmitted from the external entity 115 to the mobile device 120. If the vehicle key has been created by the mobile device 120, then it can be signed by the external entity 115. In a corresponding way, an attestation package is transmitted from the external entity 115 to the motor vehicle 105. The digital vehicle key and the attestation package comprise complementary cryptographic information which is secured against manipulation as result of being signed by the external entity 115. Thus, the attestation package can be used only by the motor vehicle 105, and the digital vehicle key can be used only by the mobile device 120. On the basis of the cryptographic information, the participants 105, 120 can identify and authenticate each other unambiguously.

In a step 235, the attestation package is received by the motor vehicle 105. Following verification, a content of the attestation package can be stored in a secure memory of the motor vehicle 105 or the control device 110. In a corresponding way, in a step 240 the digital vehicle key can be received by the mobile device 120. Following an optional check, the vehicle key can be stored in a secure memory of the mobile device 120. In another embodiment, the vehicle key is produced by the mobile device 120 and transmitted to the external entity 115 for signature. The vehicle key transmitted back can likewise be stored in the secure memory of the mobile device 120.

The vehicle key stored on the mobile device 120 can then be presented to the motor vehicle 105. The presentation comprises the exchange of cryptographic messages on the basis of the vehicle key and information from the attestation package between the mobile device 120 and the motor vehicle 105. In particular, two-sided authentication can be carried out. A corresponding transaction is described more accurately as a “Standard Transaction” in the technical specification of the CCC.

If the validation of the vehicle key was successful, then, in a step 245, a predetermined security function of the motor vehicle 105 can be enabled. The security function can in particular comprise the unlocking of a vehicle door or vehicle flap, the starting of a drive motor or another control which is required to use the motor vehicle 105 as intended.

By means of the techniques described herein, a process with which the user 125 obtains a digital vehicle key for a motor vehicle 105 can be significantly simplified. In particular when a plurality of usable motor vehicles 105 are beside one another, the user 125 can easily assess the motor vehicles 105 and optionally obtain further information about a motor vehicle 105 in the manner described. On the basis of an identification of the motor vehicle 105 transmitted, a digital vehicle key for the motor vehicle 105 can be created quickly and securely and transmitted to the mobile device 120 of the user 125.

The technique described can advantageously be used in particular when a motor vehicle 105 can potentially be used by a large number of users 125 or when a user 125 can potentially use a large number of motor vehicles 105 of a vehicle fleet. The process of choosing a motor vehicle 105 and the process of requesting a digital vehicle key for the motor vehicle 105 can be integrated with each other in an improved way and implemented in an accelerated manner.

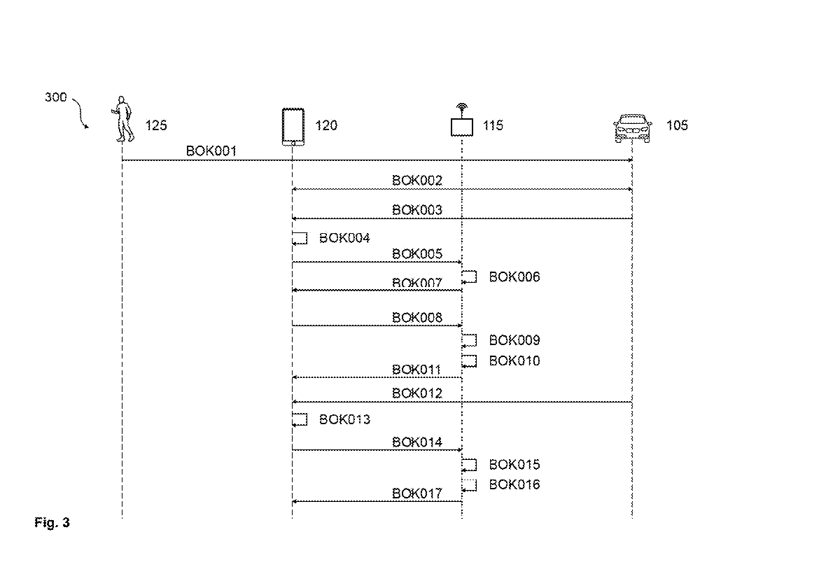

FIG. 3 shows details of the method 200 from FIG. 2 in various alternative variants or embodiments. In a manner similar to that in FIG. 2, symbols for the user 125, the mobile device 120, the external entity 115 and the motor vehicle 105 are illustrated in the horizontal direction. Time is plotted from top to bottom in the vertical direction.

In a step BOK001, the user 125 holds the mobile device 120 near the motor vehicle 105 such that NFC communication can take place. In a step BOK002, authentication is optionally carried out between the mobile device 120 and the motor vehicle 105.

In a first variant, it is assumed that the motor vehicle 105 is part of a vehicle fleet, which is managed by means of a server based owner device (SBOD). The vehicle fleet can, for example, comprise a number of rental vehicles or vehicles belonging to an organization.

In a step BOK003, one or more parameters are provided by the motor vehicle 105, comprising vehicle data about the motor vehicle 105. Such vehicle data can, for example, comprise an identification of a manufacturer of the motor vehicle, an identification of a vehicle make or a vehicle model, an identification of the motor vehicle, an identification of an operator of the vehicle fleet, an identification of a vehicle fleet to which the motor vehicle 105 belongs, or another parameter. Formalization of such information is currently not yet comprised by technical proposals from the CCC.

In a step BOK004, a vehicle catalog which comprises information about motor vehicles from the vehicle fleet can be searched by the mobile device 120. If the motor vehicle 105 in question cannot be found in the vehicle catalog, then the method 300 can be terminated.

If the motor vehicle 105 is a rental vehicle, then in a step BOK005 a request to provide basic vehicle data can be transmitted to the external entity 115. One or more of the parameters from step BOK003 can be provided as an argument for the request. The external entity 115 can then compile the basic information that is being looked for in a step BOK006. Such information can comprise, for example, the name of a provider, a description of features or capabilities of the motor vehicle 105 or a rental price. The compiled information can be supplied back to the mobile device 120 in a step BOK007.

On the other hand, if the motor vehicle 105 is a fleet vehicle from a company or a private organization, then a similar sequence can be carried out. In a step BOK008 (cf. BOK005), a request to provide basic vehicle data can be transmitted to the external entity 115. One or more of the parameters from step BOK003 can be provided as an argument for the request. The external entity 115 can then check, in an additional step BOK009, whether the motor vehicle 105 can be booked under the given circumstances. In particular, it is possible to check whether the rental of the motor vehicle 105 by the person 125 and/or at the current time is possible. After that, in a step BOK010 (cf. BOK006), the basic information looked for can be compiled. The information can, for example, comprise a description of the vehicle fleet, an individual or entity responsible for the motor vehicle 105, a description of features or capabilities of the motor vehicle 105 or a use restriction. The compiled information can be supplied back to the mobile device 120 in a step BOK011 (cf. BOK007).

In a second variant, it is assumed that the motor vehicle 105 is part of a vehicle fleet which is managed by means of a server based friend device (SBFD). In particular, ad hoc access to the motor vehicle 105 can be made possible by the SBFD.

In a step BOK012 (cf. BOK003), one or more parameters which comprise vehicle data about the motor vehicle 105 are provided by the motor vehicle 105. In a step BOK013 (cf. BOK004), a vehicle catalog which comprises information about motor vehicles from the vehicle fleet can be searched by the mobile device 120.

If the motor vehicle 105 is a private vehicle, steps BOK014 to BOK017, which correspond in pairs to steps BOK008 to BOK011, can then be carried out.

Following the steps described, details relating to booking the motor vehicle 105 can be negotiated. The details can, for example, comprise a rental price, a start or an end of the use. In addition, it is possible to collect information which is required to create a vehicle key for the motor vehicle under the negotiated conditions. Finally, the vehicle key for the use of the motor vehicle 105 can be produced and validated for the mobile device 120, as described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of designations

100 System

105 Motor vehicle

110 Control device

115 External entity

120 Mobile device

125 User

130 Processing device

135 First wireless interface; near-field communication, NFC

140 Second wireless interface; BT / BLE

145 Third wireless interface; mobile radio / WLAN

150 Processing device

155 First wireless interface

160 Second wireless interface

165 User interface

170 Processing device

175 Wireless interface; mobile radio, WLAN

180 Vehicle data

185 Identification

190 Feature, capability

195 Address of external entity

200 Method

205 Produce wireless connection

210 Provide vehicle data

215 Request further information

220 Provide further information

225 Provide information to user; acquire input

230 Create vehicle key, transmit

235 Receive attestation

240 Receive vehicle key; present vehicle key

245 Validate vehicle key, enable function

BOK001 Mobile device on vehicle door

BOK002 Authentication

BOK003 Provide parameters

BOK004 Interrogate vehicle catalog

BOK005 Request basic service information

BOK006 Compile basic service information

BOK007 Provide basic service information

BOK008 Request basic service information

BOK009 Vehicle available?

BOK010 Compile basic service information

BOK011 Provide basic service information

BOK012 Provide CCC parameters

BOK013 Interrogate vehicle catalog

BOK014 Request basic service information

BOK015 Vehicle available?

BOK016 Compile basic service information

BOK017 Provide basic service information

What is claimed is:

1. A method for controlling a motor vehicle, the method comprising:
producing a wireless connection between the motor vehicle and a mobile device;
providing vehicle data about the motor vehicle, including an identification of the motor vehicle, to the mobile device via the wireless connection; and
producing a digital vehicle key based on the identification of the motor vehicle.

2. The method as claimed in claim 1, wherein the vehicle data comprises an indication of a feature or a capability of the motor vehicle.

3. The method as claimed in claim 1, wherein the identification comprises an indication of an external entity which is configured to produce a digital vehicle key for the motor vehicle.

4. The method as claimed in claim 2, wherein the identification comprises an indication of an external entity which is configured to produce a digital vehicle key for the motor vehicle.

5. The method as claimed in claim 3, wherein an indication of a feature or a capability of the motor vehicle is transmitted to the mobile device by the external entity.

6. The method as claimed in claim 3, further comprising:
creating a digital vehicle key by the mobile device; and
signing the digital vehicle key by the external entity.

7. The method as claimed in claim 4, further comprising:
creating a digital vehicle key by the mobile device; and
signing the digital vehicle key by the external entity.

8. The method as claimed in claim 1, wherein the wireless connection is produced by a connection technology via which a digital vehicle key is presentable to the motor vehicle.

9. The method as claimed in claim 2, wherein the wireless connection is produced by a connection technology via which a digital vehicle key is presentable to the motor vehicle.

10. The method as claimed in claim 1, wherein the wireless connection is produced by short-range radio.

11. The method as claimed in claim 2, wherein the wireless connection is produced by short-range radio.

12. The method as claimed in claim 10, wherein the wireless connection is produced by near-field communication.

13. The method as claimed in claim 3, wherein the external entity comprises a server based owner device.

14. The method as claimed in claim 4, wherein the external entity comprises a server based friend device.

15. A control device for a motor vehicle, the control device comprising:
an interface configured to produce a wireless connection to a mobile device; and
a processing device configured to provide vehicle data about the motor vehicle to the mobile device via the wireless connection;
wherein the vehicle data comprises an identification of the motor vehicle, based on which a digital vehicle key for the motor vehicle is produceable.

16. The control device as claimed in claim 15, wherein the control device is configured to use the wireless connection to verify a digital vehicle key for the motor vehicle that is stored on the mobile device, and to enable a security function of the motor vehicle.

17. A motor vehicle comprising a control device as claimed in claim 15.

18. A mobile device comprising:
an interface configured to produce a wireless connection to a motor vehicle;
a processing device configured to receive vehicle data about the motor vehicle via the wireless interface;
wherein the vehicle data includes an identification of the motor vehicle, based on which a digital vehicle key for the motor vehicle is produceable.

19. The mobile device as claimed in claim 18, further comprising a user interface configured to provide an indication to a user, determined based on the vehicle data, of a feature or a capability of the motor vehicle.
